(19) United States
(12) Patent Application Publication
(10) Pub. No.: US 2011/0041470 A1
(43) Pub. Date: Feb. 24, 2011

(54) FLUID ASSEMBLIES COMPRISING A PURIFICATION ELEMENT

(75) Inventor: Brian Palermo, Dryden, NY (US)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, East Hills, NY (US)

(21) Appl. No.: 12/376,443

(22) PCT Filed: Aug. 17, 2007
(86) PCT No.: PCT/US07/76210

§ 371 Date: Feb. 18, 2009

Related U.S. Application Data
(60) Provisional application No. 60/840,025, filed on Aug. 25, 2006.

(51) Int. Cl. B01D 35/30

(52) U.S. Cl. 55/502; 55/495

(57) ABSTRACT

This invention relates to a fluid assembly comprising a fluid handling device (11) having a port, a substrate (12) having a fluid conduit, and a block purifier (13). The block purifier includes only one fluid flow path (14) and a purification element (15) is disposed in the fluid flow path. The block purifier is positioned between the fluid handling device and the substrate and the fluid flow path of the block purifier fluidly communicates with the port of the fluid handling device and the fluid conduit of the substrate.

### FIELD OF THE INVENTION

This invention relates to fluid assemblies. More particularly, it relates to fluid assemblies used to purify fluids, e.g., gases, including, for example, gases used in the manufacture of semiconductors. Gases used in industrial processes may be purified to remove particulate matter, such as solids, colloids, gels, and liquid particles, and chemical substances, such as homogenous or molecular contaminants. In the manufacture of semiconductors, for example, gases may be purified to remove particulate matter because particulate matter in the gases can introduce flaws into the semiconductors being manufactured.

### SUMMARY OF THE INVENTION

The present invention provides highly effective and reliable fluid assemblies. In accordance with one aspect of the invention, fluid assemblies may include a fluid handling device, a substrate, and a block purifier. The fluid handling device may be any type of device used with fluids, including, for example, a mass flow controller, a temperature sensor, a pressure sensor, or any other device that fluid flows into and/or through. The fluid handling device may include at least one port. The substrate may be any body which has one or more fluid conduits and supports one or more fluid handling devices. The block purifier may be positioned between the fluid handling device and the substrate and may include a sole fluid flow path in communication between the port of the fluid handling device and the fluid conduit of the substrate. The block purifier may further include a permeable purification element disposed in the fluid flow path. Any fluid flowing between the fluid conduit of the substrate and the port of the fluid handling device passes through the fluid flow path of the block purifier and is purified by the purification element.

Fluid assemblies of the present invention have many advantages. For example, they may have few seals. Because the block purifier may only include a single fluid flow path, seals may be located only where the fluid flow path enters and exits the block purifier, resulting in a highly leak resistant fluid assembly. Another advantage of having only a single flow path is the small and compact size of the block purifier, which reduces the size of the fluid assembly and allows for more versatile use of the block purifier while maintaining the mechanical integrity of the fluid assembly as a whole.

For some embodiments, a fluid assembly may further include a spacing element positioned between the fluid handling device and the substrate, the spacing element being separate and apart from the block purifier. For example, the block purifier may be in fluid communication with a first port, for example, an inlet port, of the fluid handling device and a first fluid conduit of the substrate. The fluid handling device may include a second port, for example, an outlet port, and the substrate may include a second fluid conduit. The spacing element may be positioned between the fluid handling device and the substrate and may include a fluid flow path in fluid communication between the second port of the fluid handling device and a second fluid conduit of the substrate. Preferably, the spacing element may have a thickness corresponding to the thickness of the block purifier.

For other embodiments, the fluid handling device may have a leg. For example, the fluid handling device may include a base. The block purifier may be positioned between one region of the base of the fluid handling device and the substrate. The block purifier may be in fluid communication between a first port, for example, an inlet port, of the fluid handling device and a first fluid conduit of the substrate. The fluid handling device may include a second port, for example, an outlet port, and the substrate may include a second fluid conduit. At another region of the base, the fluid handling device may include a leg extending to the substrate. The leg may include the second port of the fluid handling device, which may be in direct fluid communication with the second fluid conduit of the substrate.

For other embodiments of the invention, the fluid handling device and/or the substrate may include a cut-out and the block purifier may be disposed in the cut-out. The cut-out may provide space for the block purifier such that the fluid handling device can be mounted directly on the substrate, thereby decreasing space requirements and providing a more compact fluid assembly.

### BRIEF DESCRIPTION OF THE DRAWINGS

FIG. 1 is a cross-sectional view of a block purifier.

FIG. 2 is a cross-sectional view of a fluid assembly including a spacing element.

FIG. 3 is a cross-sectional view of a fluid assembly including a fluid handling device having a base which includes a leg.

FIG. 4 is a cross-sectional view of a fluid assembly wherein a block member is disposed in a cut-out of a fluid handling device.

FIG. 5 is a cross-sectional view of a fluid assembly wherein the fluid assembly is disposed in a cut-out of a substrate.

### DESCRIPTION OF PREFERRED EMBODIMENTS

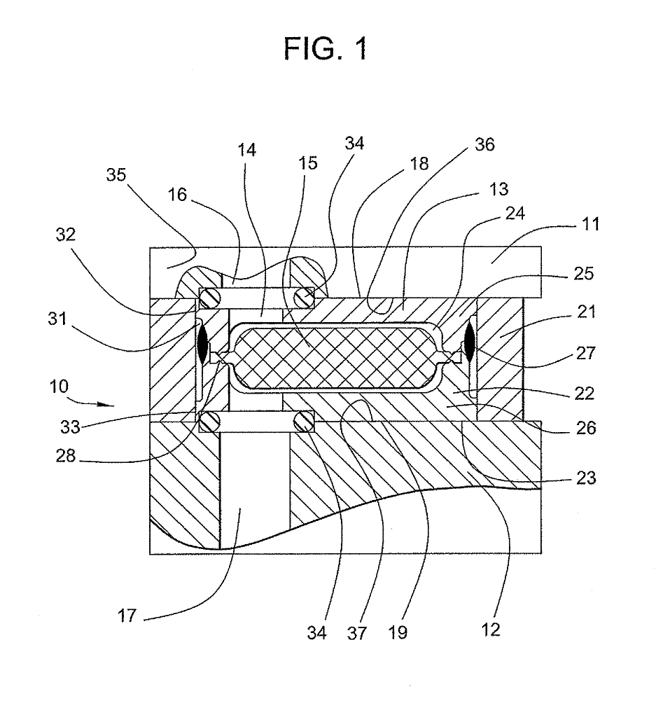

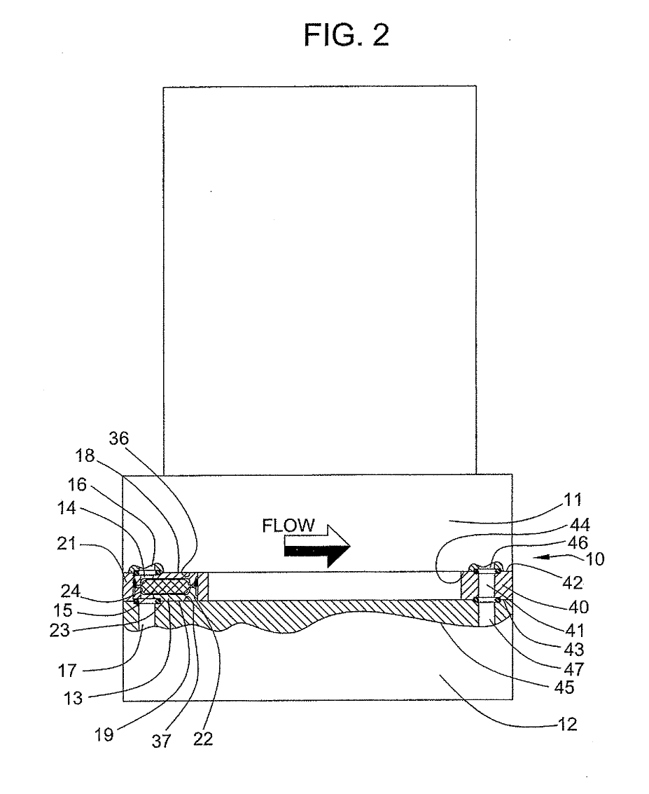

Fluid assemblies embodying the invention may be configured in a variety of ways. One of many examples of a fluid assembly 10 is shown in FIG. 1 and FIG. 2, where the fluid assembly includes a fluid handling device 11, a substrate 12, and a block purifier 13. The block purifier 13 of the fluid assembly 10 shown in FIGS. 1 and 2 may include only one fluid flow path 14 and a purification element 15 disposed in the fluid flow path 14. The fluid flow path 14 may extend through the block purifier 13, passing through the purification element 15, and may be in fluid communication with only one port 16 of the fluid handling device 11 and only one fluid conduit 17 of the substrate 12.

A block purifier may have any suitable shape, including an irregular shape or a regular shape, such as a cylindrical, disk, or rectangular parallelepiped shape, and may be configured in a wide variety of ways. For example, the block purifier may be configured in a manner similar to that disclosed in U.S. Pat. No. 6,514,323 B1 to Palermo et al. Alternatively, the block purifier may be configured in a manner similar to that disclosed in U.S. Provisional Patent Application No. 60/840,024 entitled “Purification Assemblies, Purification Units, and Methods of Assembling Purification Assemblies”, filed on Aug. 25, 2006, and listing Brian Palermo as the inventor. Both U.S. Pat. No. 6,514,323 B1 and U.S. Provisional Patent Application No. 60/840,024 are incorporated herein by reference to further support features of the block purifier.

The block purifier 13 may include one or more mounting surfaces, e.g., opposite mounting surfaces 18, 19. When the block purifier 13 is installed between a fluid handling device 11 and a substrate 12, one of the mounting surfaces 18 may face and contact a corresponding mounting surface on the fluid handling device 11 and another mounting surface 19 may face and contact another corresponding mounting surface on the substrate 12. In the embodiment illustrated in FIG. 1, the block purifier 13 includes two substantially flat mounting surfaces 18, 19 on opposite sides of the block purifier 13 and the sole flow path 14 opens onto each mounting surface 18, 19. The block purifier 13 may be permanently or removably mounted to the fluid handling device 11 and/or the substrate 12 in any suitable way including, for example, by bolting through bolt holes in the block member, by welding, or by an interference fit.

The sole fluid flow path 14 may extend between the mounting surfaces 18, 19 of the block purifier and provide fluid communication between, for example, an inlet port 16 of the fluid handling device 11 and a fluid conduit 17 of the substrate 12. To this end, the fluid flow path 14 may extend between the mounting surface 18 facing the fluid handling device 11 and the mounting surface 19 facing the substrate 12. Generally, the flow path may be variously configured. The flow path may have, for example, any suitable configuration, such as a straight-line configuration or an L-shaped configuration, and may have any cross-sectional configuration, such as a circular configuration. Also, the flow path may pass straight through the block purifier with openings on opposite sides of the block purifier being coaxial, or alternatively, may be offset with openings on opposite sides of the block purifier not being coaxial. The flow path openings on the mounting surfaces may be standardized to accommodate openings on the substrate and the fluid handling device.

The block purifier may comprise a block member having the sole fluid flow path and a purification element in the fluid flow path. The block member may have any suitable shape, including an irregular shape or a regular shape, such as a cylindrical, disk-shaped or rectangular parallelepiped shape, and may be variously configured. For example, the block member may comprise a single unitary or integral block member or it may comprise a plurality of pieces attachable to one another to form the block member. When the block member comprises two or more pieces attachable to one another, the pieces may be permanently fixed to one another or removably attached. For example, the pieces, may be welded, bolted, threaded, or interference fit to one another. The block member may have a cavity in which the purification element is disposed and through which the sole fluid flow path extends.

Alternatively, the block purifier 13 may comprise a block member 21 and a fitting 22. The block member 21 may include a socket 23 and the fitting 22 may be fit in the socket 23 of the block member 21. In some embodiments, the block member 21 may not have any fluid flow paths. The fitting 22 may include a cavity 24 in which the purification element 15 may be disposed, and the sole fluid flow path 14 of the block purifier 13 may extend through the fitting 22 and include the cavity 24. The fitting 22 may have any suitable configuration, including an irregular configuration or a regular configuration, such as a cylindrical, disk-shaped or rectangular parallelepiped configuration. The fitting 22 may comprise a single unitary or integral fitting or it may comprise a plurality of pieces 25, 26 attachable to one another to form the fitting 22. Although the two pieces 25, 26 shown in FIG. 1 have similar configurations, they may have very different configurations, for example, different shapes and/or different dimensions, such as different thicknesses. When the fitting comprises two or more pieces attachable to one another, the pieces may be permanently fixed to one another, for example, by welding, or removably attached, for example, by bolting. In the illustrated embodiment, the two pieces 25, 26 may be permanently attached by a weld 27.

The fitting 22 shown in FIG. 1 includes two pieces 25, 26 that are attachable to each other and define the cavity 24 which contains the purification element 15. The sole fluid flow path 14 may include the cavity 24, and the openings of the fluid flow path 14 which open onto the mounting surfaces 18, 19 may be smaller than the cavity 24, e.g., may have smaller diameters. The cavity, whether in the block member or the fitting, may have any of a wide variety of configurations, including a configuration similar to that of the purification element. The cavity 24 may be disposed in the flow path 14 at the interface between the two pieces 25, 26 of the fitting 22. Alternatively, the cavity may be disposed only in one of the plurality of pieces. For example, one of the pieces may comprise substantially the entire fitting with a hole, and the other piece may be a plug insertable into the hole. The cavity may be formed by the bottom portion of the hole and the bottom surface of the plug.

The purification element may have of a variety of suitable configurations. The purification element may be a porous body which is cylindrical, conical, disk-shaped, or dome-shaped, for example. The purification element may also have a more irregular configuration, such as a mass of fibers or a bed of particles. Preferably, the purification element is disposed in the fluid flow path in the cavity of the block member or the fitting so that a substantial amount, or more preferably all, of the gas passing through the fluid flow path passes through the purification element. The purification element may be joined to the block member or fitting in any suitable way to form a seal, such as welding, brazing, clamping, or crimping. For example, where multiple pieces 25, 26 are attached directly to one another to from the fitting 22, the purification element 15 may be held in place by the compression of the pieces 25, 26 alone. In the illustrated embodiment, the purification element 15 may be clamped between the two pieces 25, 26 of the fitting 22, for example, by compressing an edge portion of the purification element 15 in a groove 28 around the periphery of the cavity 24.

The structure and pore size of the purification element can be chosen in accordance with various factors, including, for example, the materials which are to be removed from the fluid flowing through the purification element, the maximum operating temperature, and the desired flow characteristics through the purification element. When the purification element is used for purifying gases used in semiconductor manufacture, it is preferably made of a low outgassing, bakeable, and corrosion resistant material, such as stainless steel, nickel, or a Hastelloy metal. Alternatively, it may be fashioned from a polymeric material, such as a polymeric membrane or fibrous material, or from a glass fiber material or a ceramic material. Certain types of purification elements are also described in detail in U.S. Pat. Nos. 5,490,868 and 5,545,242, which are incorporated herein by reference in their entirety to support this and other features of the present invention. The purification element may also comprise a media, e.g., a reactive media, for removing homogenous or molecular contaminants, including undesirable chemical substances, such as undesirable gaseous components, from the fluid. One example of a reactive media is disclosed in PCT Publication No. WO/0168241 to Brown et al., which is incorporated herein by reference in its entirety to support this and other features of the present invention.

The fitting 22 may be attached to the socket 23 of the block member 21 in any of numerous ways. The fitting may be permanently fixed to block member or removably attached. For instance, the fitting may be welded, bolted, threaded, press-fit, snap-fit, or friction fit to the block member. The fitting 22 may include at least one peripheral engagement surface, for example, on a side of the fitting 22, that may contact a corresponding engagement surface in the socket 11 of the block member 21. As shown in FIG. 1, the fitting 22 may include a groove 31 around its exterior which creates multiple engagement surfaces 32, 33 on the side of the fitting 22 that may contact one or more engagement surfaces in the socket 23 of the block member 21. The engagement surfaces 32, 33 of the fitting 22 may begin at the mounting surfaces 18, 19 and extend axially to the groove 31. The axial length of the engagement surfaces 32, 33 may be less than about 50% of the total axial length of the fitting 22, more preferably less than 35%, and still more preferably less than 25%. The force per area at the points of contact increases as the surface area of the engagement surfaces is decreased. This increase in pressure and force per area may provide for higher energy points and a better interference fit of the fitting 22 in the socket 23 of the block member 21. In addition, the weld 27 may extend into the groove 31 without contacting the block member 21, reducing the amount of machining that may be done to the weld 27.

The block purifier 21 may include one or more seals 34 to prevent leakage, for example, between a mounting surface of the block purifier 13 and the corresponding mounting surface of the fluid handling 11 device or between a mounting surface of the block purifier 13 and the corresponding mounting surface of the substrate 12. A seal, including a face seal, such as a C-ring seal, an O-ring seal, a W-seal, or a Z-seal, may be disposed around the flow path to seal the flow path from the exterior of the fluid assembly. For example, a face seal may be placed within a groove or recess disposed around the flow path opening at each mounting surface and within corresponding grooves or recesses that may be disposed in the mounting surfaces of the fluid handling device and the substrate. When the block purifier is mounted to the fluid handling device and/or the substrate, the seals prevent leakage between the block purifier and the fluid handling device and between the block purifier and the substrate.

The block purifier, including the block member and the fitting, may be formed from any suitable material, including a metallic material, such as stainless steel, and a polymeric material. Although different parts of the block purifier, such as the first and second pieces of the fitting, may be formed from different materials, preferably the parts of the block purifier are formed from the same material, preferably from a metal such as stainless steel.

The fluid handling device may be any type of device used with fluids, including for example, a mass flow controller, a temperature sensor, a pressure sensor, or any other device that fluid flow passes into and/or through. The fluid handling device may have one or more ports, for example, two ports. The fluid handling device may have only an inlet port or may have an inlet port and an outlet port. The fluid handling device may be configured in a wide variety of ways. For example, the fluid handling device 11 may further include a base 35 that may be generally coplanar with a mounting surface 18 of the block purifier 13. The fluid handling device 11 may also have a mounting surface 36 which contacts a mounting surface 18 of the block purifier 13. When the fluid handling device 11 includes a base 35, the mounting surface 36 of the fluid handling device 11 may be on the base 35. A port 16 of the fluid handling device 11 may extend through the base 35 and open onto the mounting surface 36.

The substrate may be any body having one or more fluid conduits. The substrate may also support one or more fluid handling devices. The substrate may have any of various configurations, including, for example, a regular configuration or an irregular configuration. The substrate 12 may also have a mounting surface 37 which contacts a mounting surface 19 of the block purifier 13. Both mounting surfaces 19, 37 may be generally coplanar. A fluid conduit 17 may extend through the substrate 12 and open onto the mounting surface 37.

In the embodiment of the fluid assembly 10 show in FIG. 1, the block purifier 13 may include only one fluid flow path 14 and a purification element 15 disposed in the fluid flow path 14. The sole fluid flow path 14 of the block purifier 13 may be aligned and sealed to a port 16, for example, an inlet port or an outlet port, of the fluid handling device 11 and a fluid conduit 17 of the substrate 12. The fluid flow path 14 may thus be in fluid communication between a port 16 of a fluid handling device 11 and a fluid conduit 17 of a substrate 12 and may extend through the block purifier 13, passing through the purification element 15. The block purifier 13 may be sandwiched between and permanently or removably connected to the fluid handling device 11 and/or the substrate 12 in any of numerous ways. For example, the fluid handling device 11 and the block purifier 13 of the fluid assembly may be bolted to the substrate 12, although any other fastening means, including, for example, welding or an interference or friction fit, may be employed. When the block purifier is removably connected to the fluid handling device and/or the substrate, it can easily be removed from the fluid assembly. This allows for easier replacement of block purifiers having spent purification units. Also, it makes it possible to substitute one block purifier for another block purifier which includes a purification element comprising a different media, so that the fluid assembly can be used to purify the fluid in many different ways.

In some embodiments the fluid assembly may further include a spacing element. For example, FIG. 2 illustrates an embodiment of the fluid assembly including both a block purifier 13 and a spacing element 40 which are separate components and may be spaced from one other. The block purifier 13 may be similar to the block purifier 13 shown in FIG. 1 and may include a sole fluid flow path 14, a block member 21 having a socket 23, a fitting 22 having a cavity 24 and disposed in the socket 23, and a purification element 15 disposed in the cavity 24 and in the fluid flow path 14. The block purifier may be positioned between a fluid handling device 11 and the substrate 12 and the fluid flow path 14 may be in fluid communication between a fluid conduit 17 of the substrate 12 and a port 16 of the fluid handling device 11.

The spacing element may be configured in a variety of ways, including, for example, as a spacing block having a shape analogous to the shape of the block purifier. The spacing block may have a thickness corresponding to the thickness of the block purifier and may be positioned between the fluid handling device and the substrate and apart from the block purifier, allowing the mounting surfaces 18, 19 of the block purifier 13 to be flat against the corresponding mounting surfaces 36, 37 of the fluid handling device 11 and the substrate 12.

The spacing element 40 may include at least one fluid flow path 41 but does not include a purification element, e.g., in the fluid flow path. The fluid flow path 41 may extend through the spacing element 40 and may terminate at mounting surfaces 42, 43 on the spacing element 40, e.g., on opposite sides of the spacing element 40. The spacing element 40 may be sandwiched between and connected to the fluid handling device 11 and the substrate 12, for example, in a manner similar to that of the block purifier 13. The mounting surfaces 42, 43 on the spacing element 40 may be sealed, e.g., by face seals, to corresponding mounting surfaces 44, 45 on the fluid handling device 11 and the substrate 12, and the fluid flow path 41 of the spacing element 40 may fluidly communicate between a second port 46, e.g., an outlet port, in the fluid handling device 11 and a second fluid conduit 47 in the substrate 12. Fluid may then flow from the first fluid conduit 17 of the substrate 12 along the sole fluid flow path 14 of the block purifier 13, where the fluid is purified by the purification element 15, into the inlet port 16 of the fluid handling device 11. The fluid may then flow through the fluid handling device 11 and from the outlet port 46 of the fluid handling device 11 along the fluid flow path 41 of the spacing element 40, without being purified, into the second fluid conduit 47 of the substrate 12.

Alternatively, a spacing element may be mounted on the substrate bridging two fluid handling devices. For example, the fluid flow path of the spacing element may directly communicate between ports of the fluid handling devices without fluidly communicating with the substrate. After flowing into a first fluid handling device via a block purifier and through the first fluid handling device, the fluid may flow from the outlet port of the first fluid handling device through the fluid flow path in the spacing element, without being purified, into an inlet port of a second fluid handling device without passing to the substrate.

As another alternative, the spacing element may not have any fluid flow paths in the spacing element, e.g., the spacing element may be solid. Such a spacing element may be particularly useful for a fluid handling device with only one port, e.g., with only an inlet port.

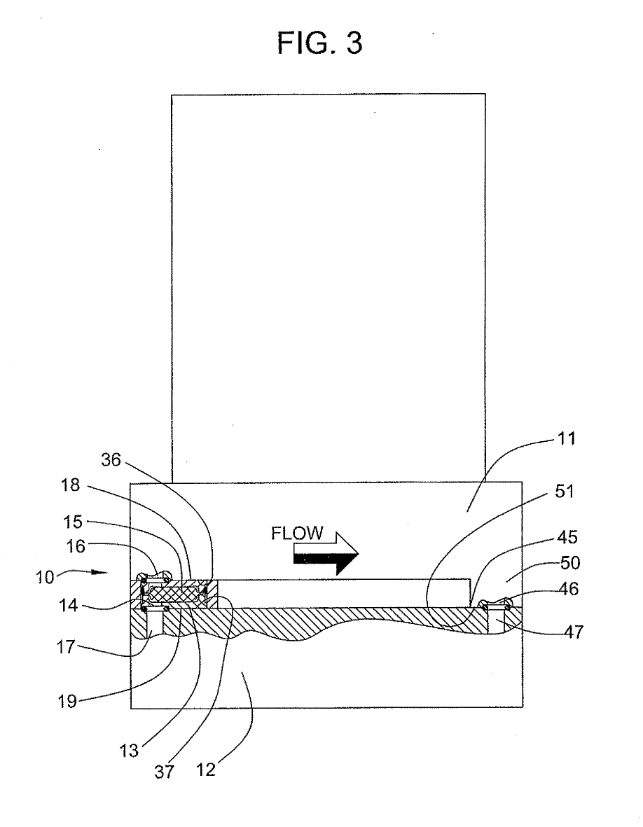

In other embodiments, the fluid assembly 10 may include a block purifier 13, a substrate 12, and a fluid handling device 11 having a leg 50. For example, as shown in FIG. 3, the block purifier 13 may be mounted between the fluid handling device 11 and the substrate 12 at one region of the base 35 of the fluid handling device 11. Another region of the base 35 of the fluid handling device 11 may include a leg 50 that extends to the substrate 12. The height of the leg 50 may correspond to the thickness of the block purifier 13. Similarly to when a spacing element is employed, the leg 50 of the fluid handling device 11 allows the mounting surfaces 18, 19 of the block purifier 13 to be flat against the mounting surfaces 36, 37 of both the fluid handling device 11 and the substrate 12. The leg may not include any ports, e.g., may be solid. However, in the illustrated embodiment the leg 50 may include a second port 46, e.g., an outlet port, of the fluid handling device 11 that communicates with a second fluid conduit 47 in the substrate 12. The leg-region of the base 35 of the fluid handling device 11 may be mounted to the substrate 12 in any of numerous ways, e.g., by bolts, by a weld, or by an interference fit, and the bottom of the leg 50 may comprise a mounting surface 51 which may be sealed, e.g., by a face seal, to a corresponding mounting surface 45 on the substrate 34. Fluid may then flow from the first fluid conduit 17 of the substrate 12 along the sole fluid flow path 14 of the block purifier 13, where the fluid is purified by the purification element 15, into the inlet port 16 of the fluid handling device 11. The fluid may then flow through the fluid handling device 11, through the leg 50, and from the outlet port 46 of the fluid handling device 11 directly into the second fluid conduit 47 of the substrate 12.

Many embodiments of the fluid assembly may include a fluid handling device having at least two ports and a substrate having at least two fluid conduits which fluidly communicate via a block purifier and a spacing element or a leg of the fluid handling device. However, in other embodiments, the ports of the fluid handling device and the fluid conduits of the substrate may all fluidly communicate via two or more block purifiers, each having only one fluid flow path therethrough. For example, the spacing block 61 shown in FIG. 2 or the leg 71 shown in FIG. 3 may be eliminated and another block purifier may be substituted for the eliminated component. The second block purifier, which may be identical to the block purifier 13 shown in FIGS. 1-3, may have only one fluid flow path. The fluid flow path may include a purification element and may be sealed between the second port of the fluid handling device and the second fluid conduit of the substrate.

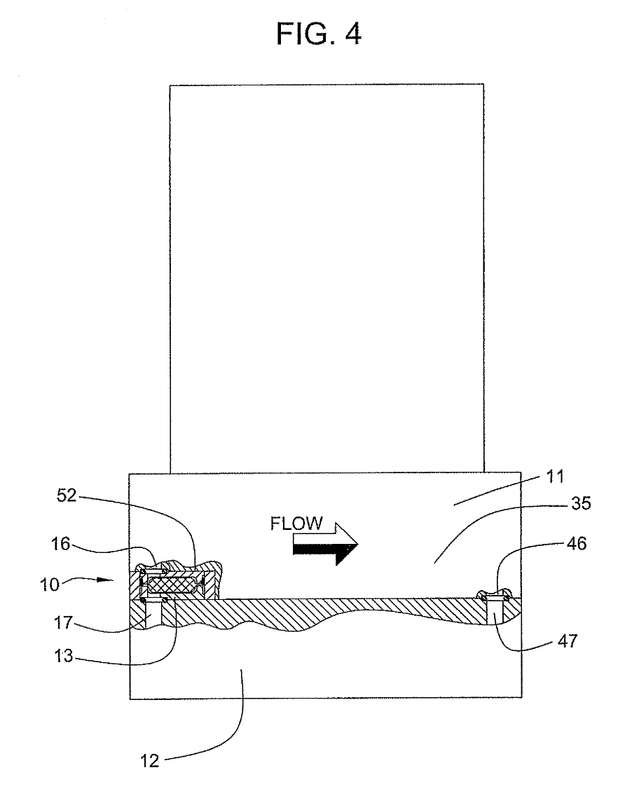

In yet another embodiment, the fluid assembly 10 may include a fluid handling device, a substrate, and a block purifier mounted in a cut-out in one or both of the fluid handling device and the substrate. For example, as shown in FIG. 4, the fluid handling device 11 may include a base 35 and a cut-out 52 may be disposed in the base 35. The block purifier 13, which may be similar to the block purifiers of FIGS. 1-3, may be permanently or removably positioned in the cut-out 52, fluidly communicating between a port 16 of the fluid handling device 11 and a fluid conduit 17 of the substrate 12. The cut-out 52 may have a depth corresponding to the thickness of the block purifier 13. The base 35 of the fluid handling device 11 may then be coplanar with the bottom of the block purifier 13, allowing the block purifier 13 and the fluid handling device 11 to sit directly on the substrate 12. This may avoid the use of a spacing element or a leg, thereby decreasing the space envelope and providing a more compact and simpler fluid assembly. The base 35 may include a second port 46, e.g., an outlet port, that is directly sealed, e.g., by face seal, to the substrate 12 in direct fluid communication with a second fluid conduit 47 of the substrate 12. Alternatively, the base may have only the single port which fluidly communicates with the block purifier.

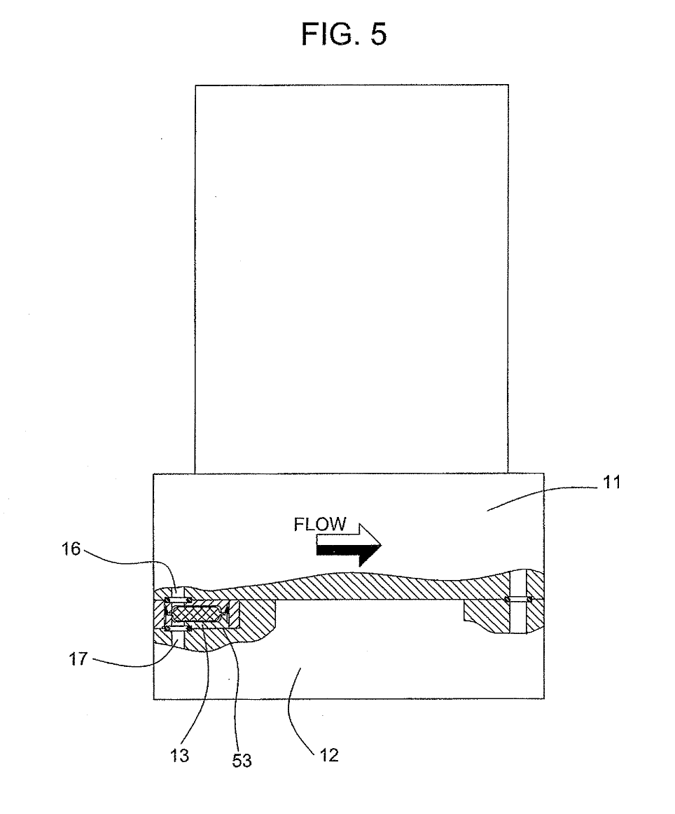

As another example, the substrate may include a cut-out and the block purifier may be disposed in the cut-out of the substrate. For example, FIG. 5 illustrates a fluid assembly 10 wherein the substrate 12 includes a cut-out 53 and the block purifier 13 is permanently or removably positioned in the cut-out 53. The block purifier 13, which may be similar to the block purifiers 13 of FIGS. 1-4, then communicates between a port 16 of the fluid handling device 11 and a fluid conduit 17 of the substrate 12. Again, the cut-out 53 may have a depth corresponding to the thickness of the block purifier 13, allowing the fluid handling device 11 to sit directly on the block purifier 13 and the substrate 12. This may also avoid the use of a spacing element or a leg, thereby decreasing space requirements and providing a more compact and simpler fluid assembly.

The fluid assemblies of the present invention have many advantages. For example, they may have few seals. Because the block purifier may include only a single fluid flow path, seals may be positioned only where the fluid flow path enters and exits the block purifier, resulting in a very effective, reliable, and lead free fluid assembly. Additionally, by having only a single fluid flow path, the block purifier is small and compact, which reduces the size of the fluid assembly and allows for more versatile use of the block purifier while maintaining the mechanical integrity of the fluid assembly as a whole.

While various aspects of the invention have been illustrated and described with reference to several embodiments, variations of these embodiments as well as completely different embodiments may be encompassed by the invention. For example, one or more of the features of any of the disclosed embodiments may be substituted and/or combined with one or more features of any other embodiment. Additionally, an embodiment may include fewer than all of the features of each disclosed embodiment. Accordingly, the invention includes all modifications encompassed within the spirit and scope of the invention as defined by the following claims.

1. A fluid assembly comprising:
a fluid handling device having a port;
a substrate having a fluid conduit;
a block purifier having only one fluid flow path and a purification element disposed in the fluid flow path, wherein the block purifier is positioned between the fluid handling device and the substrate and the fluid flow path of the block purifier fluidly communicates with the port of the fluid handling device and the fluid conduit of the substrate.

2. A fluid assembly according to claim 1, wherein the fluid assembly further includes a spacing element positioned between the fluid handling device and the substrate and separate from the block purifier, the spacing element including a second fluid flow path fluidly communicating with a second port of the fluid handling device and a second conduit of the substrate and having a thickness corresponding to the thickness of the block purifier.

3. A fluid assembly according to claim 1, wherein the fluid handling device has a base including a leg extending to the substrate and positioned apart from the block purifier, wherein the leg includes a second port and a second fluid flow path fluidly communicating with the second port and a second conduit of the substrate.

4. A fluid assembly according to claim 1, wherein the fluid handling device includes a cut-out and the block purifier is disposed in the cut-out.

5. A fluid assembly according to claim 4, wherein the fluid handling device includes a base that is coplanar with the bottom of the block purifier and the cut-out is disposed in the base.

6. A fluid assembly according to claim 1, wherein the substrate includes a cut-out and the block purifier is disposed in the cut-out.

7. A fluid assembly according to claim 1, wherein the block purifier includes a cavity in the fluid flow path and the purification element is disposed in the cavity.

8. A fluid assembly according to claim 7, wherein the block purifier further comprises a block member and a fitting and wherein the block member includes a socket and the fitting includes the cavity and is disposed in the socket of the block member.

9. A fluid assembly according to claim 8, wherein the fitting comprises a plurality of pieces attachable to form the fitting.

10. A fluid assembly according to claim 9, wherein the pieces are attached directly to one another.

11. A fluid assembly according to claim 10, wherein the pieces are welded to one another.

12. A fluid assembly according to claim 8, wherein the fitting further includes a groove into which an edge portion of the purification element fits.

13. A fluid assembly according to claim 8, wherein the fitting contains a groove extending around its exterior.

14. A fluid assembly according to claim 8, wherein the fitting is disposed in the socket through an interference or friction fit.

15. A fluid assembly according to claim 1, wherein the block purifier is bolted to the fluid handling device or the substrate.

16. A fluid assembly according to claim 1, wherein the block purifier is welded to the fluid handling device or the substrate.

17. A fluid assembly according to claim 1, wherein the block purifier is positioned between the fluid handling device and the substrate through an interference or friction fit.

18. A fluid assembly according to claim 1, wherein the fluid flow path has a straight-line configuration between opposite surfaces of the block purifier.

19. A fluid assembly according to claim 1, further comprising seals around the flow path that seal the fluid flow path from the exterior of the fluid assembly.

20. A fluid assembly according to claim 19, wherein at least one seal is a face seal.

21. A fluid assembly according to claim 1 wherein the fluid handling device includes a second port and the substrate includes a second fluid conduit and wherein the second port and the second conduit fluidly communicate independently of the block purifier.

22. A fluid assembly according to claim 1, wherein the block purifier includes a block member and the purification element is welded to the block member.

23. A fluid assembly according to claim 1, wherein the purification element comprises a metal purification medium.

24. A fluid assembly according to claim 1, wherein the fluid handling device has only one port in communication with the fluid conduit of the substrate.
